(19) United States
(12) Patent Application Publication
(10) Pub. No.: US 2003/0222492 A1
(43) Pub. Date: Dec. 4, 2003

(54) Locking/unlocking mechanism for headrest

(75) Inventors: Akira Nemoto, Tokyo (JP); Hiroaki Ichikawa, Tokyo (JP)

Correspondence Address: BROWDY AND NEIMARK, P.L.L.C., 624 Ninth Street, N.W., Washington, DC, 20001-5303, US

(73) Assignee: Tachi-S Co., Ltd, Tokyo (JP)

(21) Appl. No.: 10/157,950

(22) Filed: May 31, 2002

(51) Int. Cl. B60N 2/48

(52) U.S. Cl. 297/410

(57) ABSTRACT

A locking/unlocking mechanism for headrest, which is provided in a headrest holder in which a headrest stay is slidably inserted, comprising: an elastic lock element secured in the headrest holder; and an unlocking hole so formed in the headrest holder as to lead to the elastic lock element. The elastic lock element can be engaged in an ordinary stopper notch formed in the headrest stay to prevent removal of the headrest from a seat back of seat, but can be disengaged therefrom by inserting a tool into the unlocking hole so as to resiliently bend the elastic lock element away from the stopper notch, thereby allowing removal of the headrest from the seat back. Preferably, the elastic lock element is formed in a generally “U” shape.

### BACKGROUND OF THE INVENTION

1. Field of the Invention

The present invention relates to a mechanism for locking and unlocking a headrest for automobile.

2. Description of Prior Art

Normally, a headrest for use with an automotive seat has a pair of headrest stays projecting donwardly therefrom. Via those two headrest stays, the headrest is mounted and supported on the seat back of the automotive seat. In most cases, a pair of headrest holders are utilized to support the respective two headrest stays upon a seat back frame which is provided in the seat back. Each headrest holder is fixed on the top of seat back frame and of a cylindrical shape allowing insertion of the corresponding headrest stay therein. Further, a headrest vertical adjustment mechanism is provided between the headrest stays and headrest holders so that the headrest can be adjustably raised and lowered via the headrest holders according to the physique and head position of a user sitting on the seat.

Due to the cylindrical body of the headrest holder, it is possible to forcibly draw and remove the headrest stay therefrom to separate the headrest from the seat back when in no use or whenever required. But, this is not always favorable because it is troublesome to insert the removed headrest or headrest stay in the headrest holder when a user sits on the seat, and, in the case of traffic accident including a collision, a great force generated thereby may draw and separate the headrest or headrest stays away from the headrest holders, resulting in a great damage to the user.

To solve those problems, there has been made available a headrest removal preventive mechanism which can be arranged in one of the two headrest holders and in the corresponding one of the two headrest stays, so as to insure preventing removal of the headrest from the seat back. A typical conventional mode of such headrest removal preventive mechanism basically comprises: a notch formed in the headrest stay; a lock piece provided in the headrest holder fixed on a seat back frame, the lock pieces being provided with a bent contact portion; and a pair of springs adapted to bias the lock piece in one direction, with such arrangement that the lock plate may be biasingly engaged in the notch to thereby completely prevent removal of the headrest from the seat back. This sort of headrest removal preventive mechanism is not designed to permit for removal of the headrest, and therefore, in the case where the headrest needs to be removed from the seat back, an unlocking arrangement will be required to release the lock plate of the headrest removal preventive mechanism from the notch formed in the headrest stay. For example, when the seat back with a headrest has to be folded down to transform its rear side into a cargo load floor, it is necessary to remove the headrest from the seat back by the unlocking arrangement. Conventionally, the typical simplified mode of the unlocking arrangement is such that a bore is formed in the headrest holder to communicate with a part of the lock plate provided therein and a suitable tool is inserted in that bore to contact and press the contact portion of the lock plate, overcoming the biasing force of the spring, so as to disengage the lock plate from the notch, thereby allowing a user to remove the headrest from the seat back.

However, such unlocking arrangement requires the two springs as well as specially designed mechanical elements and fittings between the springs and lock plate, which has been found defective in rendering the structure more complicated and requiring an increased number of parts and fittings.

### SUMMARY OF THE INVENTION

In view of the above drawbacks, it is therefore a primary purpose of the present invention to provide an improved locking/unlocking mechanism for headrest, which is much simplified in structure to achieve a reduction of costs and parts involved.

In order to attain such purpose, the locking/unlocking mechanism in accordance with the present invention is basically comprised of:

an elastic lock element securely provided in a headrest holder having through-bore, the elastic lock element including a engagement portion for engagement in a stopper notch of the headrest stay, wherein the engagement portion is resiliently bendable toward and away from the through-bore of headrest holder; and

a hole formed in the headrest holder in such a manner as to allow an unlocking tool to be inserted therethrough to contact and bend the engagement portion of elastic lock element resiliently in a direction away from the through-bore of headrest holder, thereby allowing for disengagement of the engagement portion from the stopper notch.

Accordingly, this mechanism allows for direct use of an ordinary stopper notch of headrest stay, and further, one elastic lock element and one unlocking hole are only provided in the headrest holder as a principal element for locking/unlocking relation with such stopper notch, thus not requiring any other separate mechanical parts found in the prior art. This very simplified structure not only insures a failure-free unlocking effect, but also achieve a high reduction of costs and parts involved.

Preferably, the elastic lock element may be formed in a generally “U” shape including the engagement portion, a securing portion, and a bent portion defined between the engagement and securing portions. In this mode, it may be so arranged that a hollow is formed in the headrest holder, and that the engagement portion is movably disposed in that hollow at a point adjacent to the hole of headrest holder, while the securing and bent portions are securely disposed in the hollow. Preferably, the generally “U” shaped lock element may be formed from a wire spring or a plate spring.

Other various features and advantages will become apparent from reading of the descriptions hereinafter, with reference to the annexed drawings.

### BRIEF DESCRIPTION OF THE DRAWINGS

FIG. 1 is a partly broken explosive perspective view showing a constructive relation among a headrest, headrest holder, and seat back frame, in which an locking/unlocking mechanism of the present invention is incorporated;

FIG. 2 is a partly broken perspective view of a principal part of the locking/unlocking mechanism;

FIG. 3 is a cross-sectional view of the headrest holder, which shows a structure of the locking/unlocking mechanism and its specific actions;

FIG. 4 is a partly broken perspective view the principal part of the locking/unlocking mechanism; and

FIG. 5 is a perspective view showing another mode wherein an elastic lock element used is formed form a plate spring.

### DETAILED DESCRIPTION OF PREFERRED EMBODIMENT OF THE INVENTION

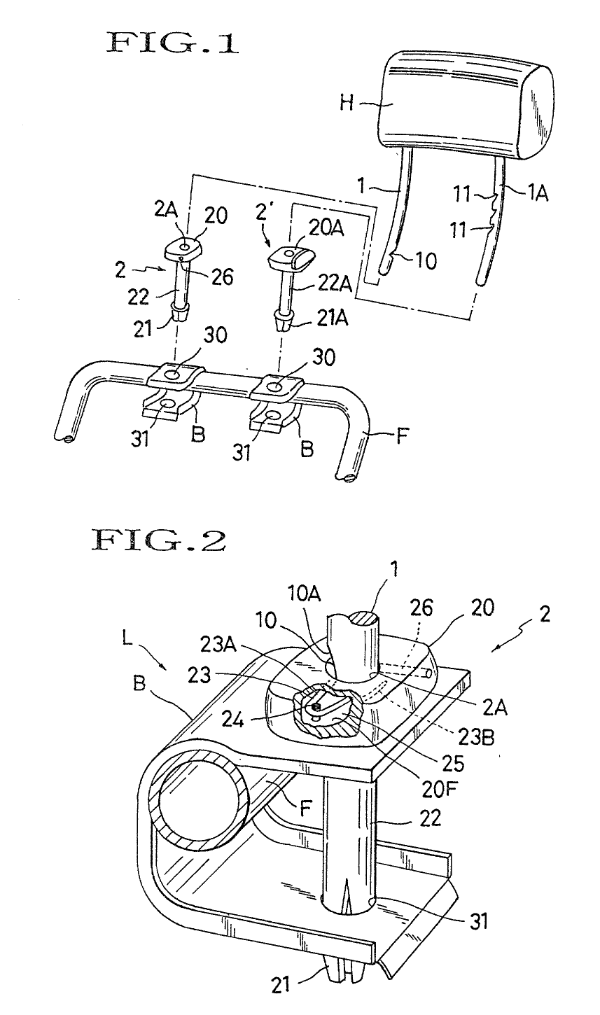

Referring to FIGS. 1 through 5, there is illustrated one exemplary mode of locking/unlocking mechanism for a headrest to be used on an automotive seat, in accordance with the present invention, the mechanism being generally designated by (L).

As shown in FIG. 1, for instance, upon the top of a seat back frame (F), a pair of securing brackets (B) (B) are fixedly provided, each of which is formed with a pair of upper and lower through-holes (30) (31) therein. While not shown, it is to be understood that all those seat back frame (F) and brackets (B) are provided within a seat back of an automotive seat by enclosing them with a suitable foam padding and cover material or other suitable upholstery, as is known in the art.

On the other hand, a headrest (H), which is to be used on the seat back of automotive seat for supporting a head of passenger, has a pair of first and second headrest stays (1) (1A) projecting downwardly therefrom. The first headrest stay (1) is shown to have a known stopper notch (10) formed in the lower end portion thereof, the stopper notch (10) being one constituent element of the headrest removal preventive mechanism as described earlier. As best shown in FIG. 4, such stopper notch (10) is of an ordinary wedge-like recessed configuration having a sloped region (10A) and a horizontal flat region (10B) which serves to normally engage a lock piece or the like, but only allows disengagement therefrom in a direction to remove the headrest (H) from the seat back.

As also known in the art, a pair of first and second headrest holders (2) (2′) are provided to supportively receive the respective first and second headrest stays (1) (1A) of the headrest (H). Both two headrest holders (2) (2′) are basically identical to each other in terms of outer shape and appearance, excepting the respective functions. The first headrest holder (2) is formed by: a cylindrical body (22); a head (20) formed in the upper end of the cylindrical body (22) having a through-bore (2A) formed therein; and a cylindrical tapered anchor portion (21) of elastic split type which is formed in the lower end of the body (22). Needless to mention, both through-bore (2A) of the head (20) and cylindrical tapered anchor portion (21) communicate with an inner longitudinal through-bore of the cylindrical body (22) to establish a passage or conduit through which the corresponding headrest stay (1) is slidably inserted. On the other hand, likewise, the second headrest holder (2′) is formed by: a cylindrical body (22A); a head (20A) formed in the upper end of the cylindrical body (22) having a through-bore (20A) formed therein; and a cylindrical tapered anchor portion (21A) of elastic split type which is formed in the lower end of the body (22A). This second headrest holder (2′) is provided with a known headrest vertical adjustment mechanism, as generally designated by (M), in the head (20A) thereof, which works to lockingly engage a selected one of the plural notches (11), so that a user can actuate the adjustment mechanism to adjustably raise and lower the headrest (H) to a desired level according to his or her physique and height. As this is well known, further explanation thereof is omitted for the sake of simplicity in description. In this connection, it is noted that the stopper notch (10) is disposed at a point adjacent to the lower end of the first headrest stay (1), while by contrast, the plural notches (11) are disposed in the second headrest stay (1A) at a point higher than the stopper notch (10).

As can be seen from FIGS. 1 and 2, the first headrest holder (2) is at its elastic anchor portion (21A) and cylindrical body (22) inserted through both two through-holes (30) (31) associated with one of the two brackets (B) and firmly retained in the bracket (B) against separation therefrom. Likewise, the second headrest holder (2′) is retained in another of the two bracket (B) against separation therefrom. As shown in FIG. 2, the head (20) of the first headrest holder (2) is exposed on the bracket (B) and thus disposed on the top of seat back frame (F).

In accordance with the shown embodiment of the present invention, a locking/unlocking mechanism (L) is provided in the head (20) of first headrest holder (20), which is operable for engagement and disengagement with and from the stopper notch (10) formed in the headrest stay (10).

Specifically, referring to FIGS. 2 to 4, the locking/unlocking mechanism (L) is essentially comprised of: a horizontally expanding hollow (25) formed in the head (20); and a generally U-shaped elastic lock element (23) secured in that hollow (25).

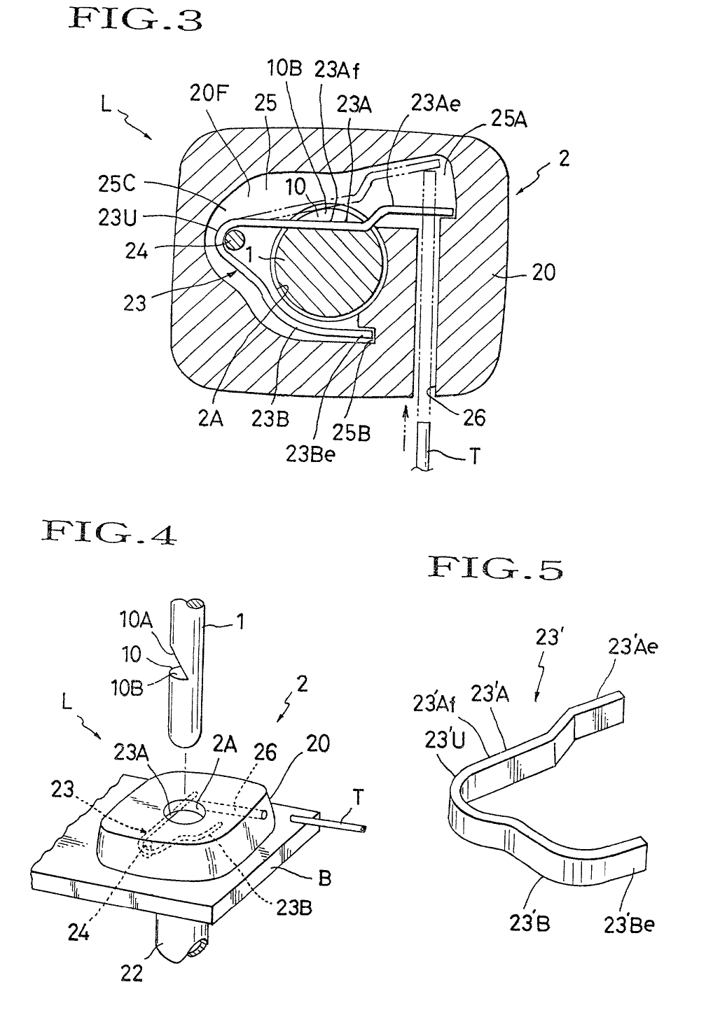

As best shown in FIG. 3 in conjunction with FIG. 2, the hollow (25) expands horizontally along the width-wise direction of the head portion (20) of headrest holder (2) so as to define a horizontal flat base wall (20F) therein and also communicates with the through-bore (2A) of the headrest holder head (20). Further, the hollow (25) is formed in the head securing portion (20) in a generally “U” fashion extending around that through-bore (2A), thus defining therein a large hollow region (25A), a narrow hollow region (25B), and a curved intermediate hollow region (25C) between the large and narrow hollow regions (25A) (25B). The large hollow region (25A) is shown to be of generally sector shape diverging from the intermediate hollow region (25C), while on the other hand, the narrow hollow region (25B) is of a short and narrow configuration extending a small distance from the intermediate hollow region (25C) as compared with the first hollow region (25A).

Formed also in the head (20) of headrest holder (2) is an unlocking hole (26) in a through communication with the large hollow region (25A). As best shown in FIG. 3, the unlocking hole (26), which forms a part of the locking/unlocking mechanism (L), extends from one side wall of the head (20) to the large hollow region (25A) therein. Thus, it follows that the unlocking hole (26) has an outwardly opened side at that one side wall of head (20) and an inwardly opened side at the large hollow region (25A).

Designation (24) denotes a pin formed in the hollow (25), which is adapted to supportively retain the elastic lock element (23). The pin (25) is situated at the intermediate hollow region (25C) and projects from the flat base wall (25F) to an upper flat wall of the hollow (25) opposite to the flat base wall (20F) as understandable from FIG. 2.

As shown in FIGS. 2 to 4, the elastic lock element (23) may be a generally U-shaped lock piece of wire spring type which is formed by bending one piece of wire spring in a generally “U” shape. As illustrated, this wire-spring-type lock element (23) may be so configured to have, defined therein, a long wire portion (23A), a short wire portion (23B) and bent wire portion (23U). As best seen in FIG. 3, the long wire portion (23A) includes a rectilinear lock part (23Af) extending rectilinearly from the bent wire portion (23U) and terminating in a contact end part (23Ae) defined in such a manner as to offset outwardly from the rectilinear lock part (23Af). By contrast, the short wire portion (23B) extends curvilinearly from the bent wire portion (23U) and terminates in a generally rectilinear securing end part (23Be).

As in FIG. 3, by way of example, the wire-spring-type lock element (23) is securely set in place within the hollow (25) such that the bent wire portion (23U) thereof is embracingly contacted about a part of the pin (24), while the long and short wire portions (23A) (23B) thereof are situated on the opposite sides of the through-bore (2A). In this regard, the long wire portion (23A) of the spring (23) extends through one side of the through-bore (2A), passing through a local small area of circular cross-section of the through-bore (2A) in a direction to the large hollow region (25A), while on the other hand, the short wire portion (23B) of the spring (23) extends curvilinearly along another side of the through-bore (2A) in a direction to the small hollow region (25B). The end part (23Be) of short wire portion (23B) is securely fitted in the small hollow region (25B). Accordingly, about half of the lock piece (23), excepting the long wire portion (23A), is positively retained against movement due to contact with the pin (24) and engagement in the narrow hollow region (25B). On the other hand, the contact end part (23Ae) of long wire portion (23A) extends adjacent to and across the inwardly opened side of the unlocking hole (26) which opens inwardly of the large hollow region (25A).

Now, a description will be made of how to use the above-constructed locking/unlocking mechanism (L).

As can be seen from FIGS. 1 to 4, the headrest stay (1) can be inserted into the through-bore (2A) of headrest holder (2) by forcing the round lower end of the stay (1) into between the long wire portion (23A) of lock element (23) and the through-bore (2A). Although not shown, it is to be understood that, when a user inserts the headrest stay (1) into the through-bore (2A), that long wire portion (23A) is caused by the sliding contact of the round lower end of the stay (1) to resiliently move in a direction away from the short wire portion (23B) relative to the pin (24), thus allowing the stay (1) to enter into the through-bore (2A), and then, the rectilinear lock part (23Af) of lock piece (23) is first brought to engagement in the stopper notch (10) of headrest stay (1). But, an ordinary force applied by the user to insert the headrest stay (1) in the through-bore (2A) sufficiently causes that lock part (23Af) to smoothly rides over the sloped region (10A) of stopper notch (10). In that way, the headrest stay (1) is inserted at a desired point in the corresponding headrest holder (2) via the previously described vertical headrest adjustment mechanism, so that the headrest (H) is supported at a proper level upon the top of seat back frame (F) (or seat back).

When it is now desired to remove the headrest (H) from the seat back frame (F), the user has to draw the headrest (H) or headrest stays (1) (1A) upwardly from the respective two headrest holders (2) (2′) until the stopper notch (10) of the headrest stay (1) is lockingly engaged with the lock part (23Af) of lock piece (23). At this moment, the lock part (23Af) itself, upon its snappingly being engaged in the stopper notch (10), is contacted with the horizontal flat region (10B) of the stopper notch (10), whereby the headrest stay (1) is completely prevented against removal from the corresponding headrest holder (2). Then, as indicated in FIG. 3, an unlocking tool (T) (rod) is inserted in the unlocking hole (26) so that the forward end thereof is thrust therethrough to contact and press the contact end part (23Ae) of elastic lock element (23). As a result thereof, the lock part (23Af) of the lock element (23) is rotatively displaced by the end of tool (T) relative to the curved part (23U) thereof within the sector-like large hollow region (25A) and disengaged from the stopper notch (10). Hence, the headrest stay (1) is released from the locked state and allowed to be removed from the through-bore (2A), as understandable from FIG. 4.

FIG. 5 shows another alternative mode of the elastic lock element (23) which may be provided in the headrest holder (2), having exactly the same functions as those of the above-described wire-spring-type lock element. In this mode, in place of the wire spring, one piece of plate spring is bent in a generally “U” shape to provide a generally U-shaped lock element (23′) of plate spring type. Likewise in the wire-spring lock piece (23), the plate-spring-type lock element (23′) has, defined therein, a long plate portion (23′A), a short plate portion (23′B) and bent plate portion (23′U). The long plate portion (23A) includes a rectilinear lock part (23′Af) extending rectilinearly from the bent wire portion (23′U) and terminating in a contact end part (23′Ae) defined in a manner offset outwardly from the rectilinear lock part (23′Af).

Form the descriptions above, it is appreciated that the locking/unlocking mechanism (1) of the present invention is quite simplified in structure because an ordinary stopper notch (e.g. at 10) formed in headrest stay can be directly used therefor, and one elastic lock element (23 or 23′) and an unlocking hole (26) are only provided in the headrest holder (2) as a principal element for locking/unlocking relation with that stopper notch, thus not requiring any other separate mechanical parts found in the prior art. This very simplified structure not only insures a failure-free unlocking effect, but also achieve a high reduction of costs and parts involved.

It should be understood that the present invention is not limited to the illustrated embodiments, but any other modifications, replacements and additions may be applied thereto without departing from the scopes of the appended claims.

What is claimed is:

1. In combination with a seat back frame of an automotive seat and a headrest having a headrest stay formed with a stopper notch, said headrest being mounted via a headrest holder upon said seat back frame, said headrest holder having a through-bore in which said headrest stay is slidably inserted,
a locking/unlocking mechanism provided in said headrest holder, comprising:
an elastic lock element securely provided in said headrest holder, said elastic lock element including an engagement portion for engagement in said stopper notch of said headrest stay, with such an arrangement that said engagement portion is resiliently bendable toward and away from said through-bore; and
a hole formed in said headrest holder in such a manner as to allow an unlocking tool to be inserted therethrough to contact and bend said engagement portion of said elastic lock element resiliently in a direction away from said through-bore of said headrest holder, thereby allowing for disengagement of said engagement portion from said stopper notch.

2. The locking/unlocking mechanism as defined in claim 1, wherein a hollow is defined in said headrest holder, said hollow communicating with said through-bore of the headrest holder, and wherein said elastic lock element is formed in a generally “U” shape including said engagement portion; a securing portion; and a bent portion between said engagement and securing portions, and wherein said engagement portion is disposed in said hollow at a point adjacent to said hole, while said securing and bent portions are securely disposed in said hollow.

3. The locking/unlocking mechanism as defined in claim 1, wherein said headrest holder includes a head adapted to be securely mounted upon said seat back frame and a cylindrical body extending downwardly from said head, wherein said through-bore is formed in both said head and said cylindrical body, wherein said hollow and said hole are formed in said head, wherein said elastic lock element is formed in a generally “U” shape including: said engagement portion; a securing portion; and a bent portion between said engagement and securing portions, wherein said engagement portion is disposed in said hollow at a point adjacent to said hole of the headrest holder, while said securing and bent portions are securely disposed in said hollow, wherein said hollow is formed in a generally “U” shape including: a large hollow region in which said engagement portion of the generally U-shaped elastic element is movably disposed; and a small hollow region in which said securing part of the generally “U” shaped elastic element is secured.

4. The locking/unlocking mechanism according to claim 2, wherein a pin is formed in said hollow so as to retain said bent portion of the generally “U” shaped elastic element against movement.

5. The locking/unlocking mechanism according to claim 2, wherein said generally “U” shaped elastic lock element is formed from a wire spring or a plate spring.

6. The locking/unlocking mechanism as defined in claim 1, wherein, in addition to said headrest stay and said headrest holder, said headrest has another headrest stay and another headrest holder is provided, in which said another headrest stay is slidably supported, and wherein a headrest vertical adjustment mechanism is provided between said another headrest stay and said another headrest holder, said headrest vertical adjustment mechanism including a plurality of notches formed in said another headrest stay, and wherein said stopper notch is disposed near to a lower end of said headrest stay, whereas said plurality of notches are disposed in said another headrest stay at a position higher than said stopper notch.

7. In combination with a seat back frame of an automotive seat and a headrest having a headrest stay formed with a stopper notch, said headrest being mounted via said pair of headrest holders upon said seat back frame, said headrest holder having a through-bore in which said headrest stay is slidably inserted,
a locking/unlocking mechanism provided in said headrest holder, comprising:
a hollow defined in said headrest holder in such a manner as to extend around said through-bore of the headrest holder, said hollow including a region communicating with said through-bore;
a generally U-shaped elastic lock element securely provided in said hollow, said generally U-shaped elastic lock element including an engagement portion for engagement in said stopper notch of said headrest stay, with such an arrangement that said engagement portion is disposed in said region of the hollow, extending across a part of said through-bore, and is resiliently bendable in a direction to and away from said through-bore; and
a hole formed in said headrest holder in such a manner as to communicate with said region of the hollow, thereby allowing an unlocking tool to be inserted through the hole so as to contact and bend said engagement portion of said elastic lock element resiliently in a direction away from said through-bore of said headrest holder, thereby allowing for disengagement of said engagement portion from said stopper notch.

8. The locking/unlocking mechanism as defined in claim 7, wherein said generally U-shaped elastic lock element includes: said engagement portion; a securing portion; and a bent portion defined between said engagement and securing portions, and wherein said engagement portion is disposed in said region of the hollow, such that an end part of the engagement portion is positioned at a point adjacent to said hole of the headrest holder, while said securing and bent portions are secured in other area of the hollow than said region.

9. The locking/unlocking mechanism as defined in claim 7, wherein said headrest holder includes a head adapted to be securely mounted upon said seat back frame and a cylindrical body extending downwardly from said head, wherein said through-bore is formed in both said head and said cylindrical body, wherein said hollow and said hole are formed in said head, and wherein said engagement portion is disposed in said hollow at a point adjacent to said hole, while said securing and bent portions are securely disposed in said hollow.

10. The locking/unlocking mechanism according to claim 9, wherein said hollow is formed in a generally “U” shape such as to include: a large hollow region in which said engagement portion of the generally U-shaped elastic element is disposed; and a small hollow region in which said securing portion of the generally “U” shaped elastic element is secured.

11. The locking/unlocking mechanism as defined in claim 7, wherein said generally U-shaped elastic lock element is formed from a wire spring or a plate spring.

12. The locking/unlocking mechanism as defined in claim 7, wherein, in addition to said headrest stay and said headrest holder, said headrest has another headrest stay and another headrest holder is provided, in which said another headrest stay is slidably supported, and wherein a headrest vertical adjustment mechanism is provided between said another headrest stay and said another headrest holder, said headrest vertical adjustment mechanism including a plurality of notches formed in said another headrest stay, and wherein said stopper notch is disposed near to a lower end of said headrest stay, whereas said plurality of notches are disposed in said another headrest stay at a position higher than said stopper notch.
